(19) United States
(12) Patent Application Publication
(10) Pub. No.: US 2005/0277198 A1
(43) Pub. Date: Dec. 15, 2005

(54) System and method of material testing using permittivity measurements

(76) Inventors: Samuel R. Shortes, Highland Village, TX (US); Vernon Porter, Plano, TX (US)

Correspondence Address: HOWISON & ARNOTT, L.L.P, P.O. BOX 741715, DALLAS, TX, 75374-1715, US

(21) Appl. No.: 10/866,415

(22) Filed: Jun. 11, 2004

(51) Int. Cl. G01N 27/00

(52) U.S. Cl. 436/149; 422/82.01

(57) ABSTRACT

A system for material testing includes an impedance measuring circuit and an sensing element connected to the impedance measuring circuit. An analyte is proximate to the sensing element. The impedance measuring circuit measures a first impedance of the sensing element. When the analyte is exposed to an associated material, the impedance measuring circuit measures a second impedance of the sensing element.

### CROSS-REFERENCE TO RELATED APPLICATIONS

This application claims priority on provisional application 60/477,622, entitled INTEGRATED CHEMICAL ANALYSIS METHOD AND APPARATUS, filed on Jun. 11, 2003.

### TECHNICAL FIELD OF THE INVENTION

This application relates to the field of material testing, in particular using microwave frequency permittivity measurements.

### BACKGROUND OF THE INVENTION

Detecting the presence of specific chemicals, compounds or material conditions can be vitally important in a number of different fields. In medicine, the detection of specific organic compounds, chemicals or concentrations of these materials can assist in diagnosis. In business, detecting the presence of contaminants can be important to quality control or stock maintenance. In fighting crime or terrorism, detecting the presence of explosives, biological contaminants or toxins may be crucial. In construction and management of structures, equipment or vehicles, the detection of deterioration within the materials may help reduce costs and lower maintenance costs. Being able to perform the detection processes in the field, in the office may also be important.

What is needed, therefore, is an efficient, inexpensive and portable material testing process.

### SUMMARY OF THE INVENTION

A system for material testing includes an impedance measuring circuit and an sensing element connected to the impedance measuring circuit. An analyte is proximate to the sensing element. The impedance measuring circuit measures a first impedance of the sensing element. When the analyte is exposed to an associated material, the impedance measuring circuit measures a second impedance of the sensing element.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a sensing pad;

FIG. 2 illustrates a sensing pad with a specimen layer;

FIG. 3 illustrates a exposed sensing pad with a specimen layer;

FIG. 4 illustrates a rinsed exposed sensing pad;

FIG. 5 illustrates a representation of a reactive sensing pad;

FIG. 6 illustrates a representation of a reacting sensing pad;

FIG. 7 illustrates a representation of a exposed sensing pad;

FIG. 8 illustrates a representation of a reactive sensing pad;

FIG. 9 illustrates a representation of an unreacting sensing pad;

FIG. 10 illustrates a representation of an unexposed sensing pad;

FIG. 11 illustrates a functional block diagram of a material detection system;

FIG. 12 illustrates a graph of the resonant frequency of an unbuffered oscillator during a permittivity measurement process;

FIG. 13 illustrates a flowchart of a permittivity measurement process;

FIG. 14 illustrates a flowchart of a permittivity measurement process for an array of sensing pads;

FIG. 15 illustrates a typical silicon wafer arrangement;

FIG. 16 illustrates a material detection array integrated circuit;

FIG. 17 illustrates charts of a pad identifiers and material identifiers;

FIG. 18 illustrates a sensing pad integrated circuit;

FIG. 19 illustrates a material detection system including a frequency divider;

FIG. 20 illustrates a material detection system including a standard load;

FIG. 21 illustrates a schematic diagram of a modified Colpitts oscillator;

FIG. 22 illustrates a descending square linear antenna configuration;

FIG. 23 illustrates a progressive square open loop linear antenna configuration;

FIG. 24 illustrates a descending spiral closed loop linear antenna configuration;

FIG. 25 illustrates an quarantined material detection array integrated circuit;

FIG. 26 illustrates a heated sensing pad;

FIG. 27 illustrates a heated material detection array;

FIG. 28 illustrates a sensing pad with a temperature sensor;

FIG. 29 illustrates a portable material detection device;

FIG. 30 illustrates a cross-section of a portable material detection device in use;

FIG. 31 illustrates a portable material detection device;

FIG. 32 illustrates a top view of a portable material detection device;

FIG. 33 illustrates a bottom view of a portable material detection device;

FIG. 34 illustrates a bottom view of a portable material detection device;

FIG. 35 illustrates a bottom view of a portable material detection device;

FIG. 36 illustrates a portable material detection device;

FIG. 37 illustrates a portable material detection device in use with remote processing;

FIG. 38 illustrates a portable material condition detection device;

FIG. 39 illustrates a portable material condition detection device in use with remote processing;

FIG. 40 illustrates a functional block diagram of a portable material condition detection device;

FIG. 41 illustrates a flow chart of a material condition detection process;

FIG. 42 illustrates a material condition detection system.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

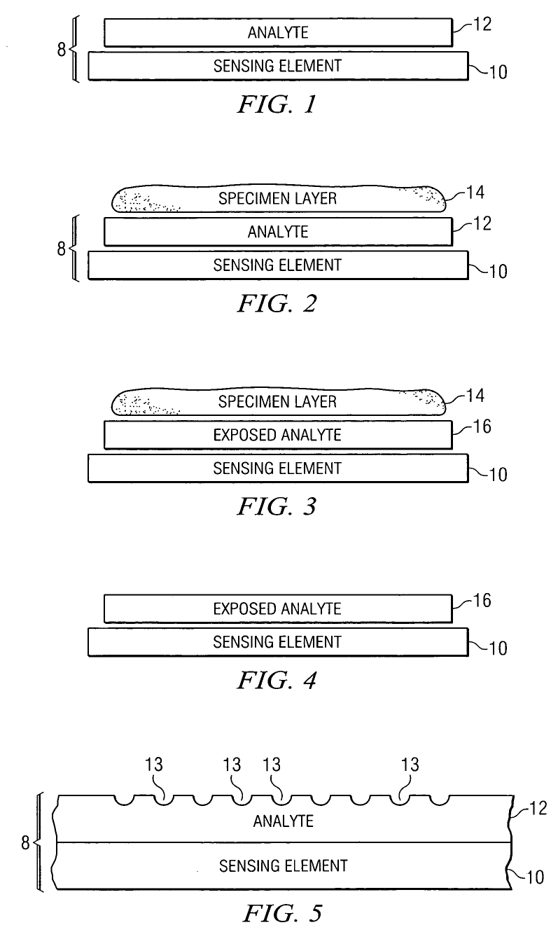

With reference to FIG. 1, a functional block diagram of the basic testing pad configuration is shown. A testing pad 8 is formed by an sensing element 10 placed in close proximity to a analyte 12. The analyte 12 acts as a dielectric relative to the sensing element 10. The sensing element 10 is typically made from a conductive material such as a metal. The analyte 12 is typically a non-conductor or at least less conductive than the sensing element 10. The composition of the analyte 12 is chosen to have specific dielectric and reactive properties, depending on the specific material being tested. In particular, the analyte 12 is chosen such that it reacts upon contact with an associated material and where the product of the reaction has a different permittivity than the unexposed analyte 12. The analyte 12 may be chosen to react similarly with a class of materials or a specific concentration of an associated material. The analyte 12 should be chosen so that it doesn't react with another potentially present material that creates a reaction product with permittivity that is measurably indistinguishable from the permittivity of the reaction product formed by contact with the associated material. The presence of the analyte 12 changes the conductive properties of the sensing element 10 at least over a determined range of frequencies.

With reference to FIG. 2, a functional block diagram of the basic testing pad configuration as the testing of a sample 14 is initiated. The specimen layer 14 is placed in contact with the analyte 12. The testing pad 8 is designed to be specifically capable of testing the presence or concentration of an associated material or group of materials in the sample 14. The specimen layer 14 may be in any state of matter, although typically the specimen layer 14 will be a gas or liquid. The presence of the specimen layer 14 will typically change the conductive properties of the sensing element 10.

With reference to FIG. 3, a functional block diagram of the basic testing pad configuration in the exposed stage of testing. The analyte 12 composition has been selected so that the analyte 12 chemically reacts with the material being tested for. The chemical reaction transforms the analyte 14 into exposed layer 16. Exposed layer 16 has different dielectric properties, particularly a different permittivity than the analyte 14. Specimen layer 14 may change composition as a result of the chemical reaction. The presence of the exposed layer 16 and the specimen layer 14 will typically change the conductive properties of the sensing element 10. The change in the conductive properties of the sensing element 10 due to the transformation of the analyte 12 to the exposed layer 16 while the specimen layer is present may be used to detect the presence of the material, but the quality of the change or the speed of the reaction may make this measurement difficult. More typically, the specimen layer 14 is washed away after sufficient time has elapsed to permit the reaction to take place.

With reference to FIG. 4, a functional block diagram of a basic exposed pad is shown. After a predetermined lapse of time, the specimen layer 14 has been washed away, exposing the exposed layer 16 or an unexposed analyte 12. Because the exposed layer 16 has a measurably different permittivity from the unexposed analyte 12, each affects the conductivity of sensing element 10. By measuring the change in conductivity of the sensing element 10, the presence of a exposed layer 16 can be distinguished from the presence of an unexposed analyte 12. Because the exposed layer 16 is formed by reacting the analyte 12 with the associated material, the presence of the exposed layer 16 establishes the presence of the associated material in sample 14.

With reference to FIG. 5, a representational diagram of a simple testing pad 8 is shown. An sensing element 10 is proximate to an analyte 12. An nalyte 12 is shown having receptors 13 which allow connection to an associated material 18. This relationship between the receptors 13 and the associated material 18 is shown by semi-circular receptors 13 and circular associated material 18. In chemical terms, this relationship may represent an affinity for the chemicals in the analyte 12 to react, be absorbed or otherwise interact with the chemicals of the associated material 18.

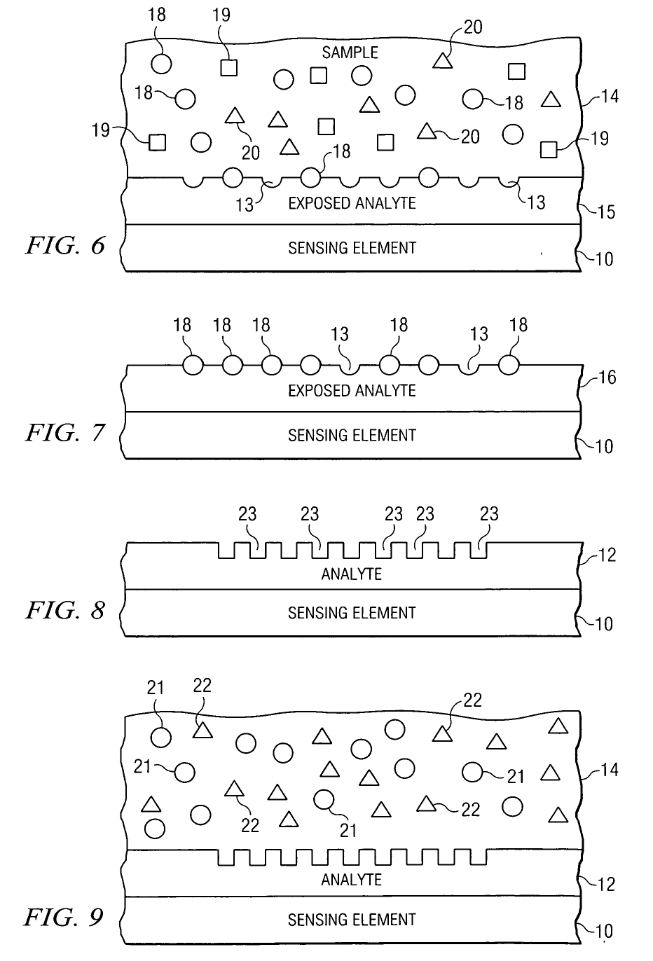

With reference to FIG. 6, a representational diagram of a simple testing pad during the exposure phase is shown. A sample 14 has been placed proximate to the analyte 12. Sample 14 contains materials 18, 19 and 20, including associated material 18. The materials 18, 19 and 20 may be molecules or elements in a gas or liquid, dissolved in a liquid, suspended in a liquid or particles in a particulate solid. As the associated material 18 come in contact with the analyte 12, a connection takes place and the analyte 12 is transformed into a exposed analyte 15. Representationally, the circular associated material units 18 attach themselves to the semi-circular receptors 13, while the square material units 19 and the triangular material units 20 do not attach. Chemically, the associated material 18 has an affinity to react, be absorbed or otherwise interact with the analyte 12 in a way that changes the permittivity of the analyte, while the other materials 19 and 20 do not.

With reference to FIG. 7, a representational diagram of a exposed testing pad is shown. After sufficient time has elapsed to allow the connection between the associated material 18 and the analyte 12 to be substantially completed, the sample 14 is washed away. A exposed analyte 16 is left in proximity to the sensing element 10. By measuring the change in conductivity of the sensing element 10, a change in permittivity from the unexposed analyte 12 to the exposed analyte 16 can be detected. Because the exposed analyte 16 is formed by exposure to associated material 18, the presence of associated material 18 in sample 14 can be established.

With reference to FIG. 8, a representational diagram of an unexposed testing pad 8 is shown. An sensing element 10 is proximate to an unexposed analyte 12. Unexposed analyte has a multitude of square shaped receptors 23 which would combine with square shaped particles. This representation of square shaped particles and square receptors 23 represent an affinity for analyte 12 to connect with an associated material.

With reference to FIG. 9, a representational diagram of an unreacting testing pad is shown. Sample 14 is placed in contact with unexposed analyte 14. The sample 14 contains materials such as circular particles 21 and triangular particles 22, but no square particles which represent the associated material the analyte 12 is designed to detect. Because there are no square particles, the analyte 12 is unreacting.

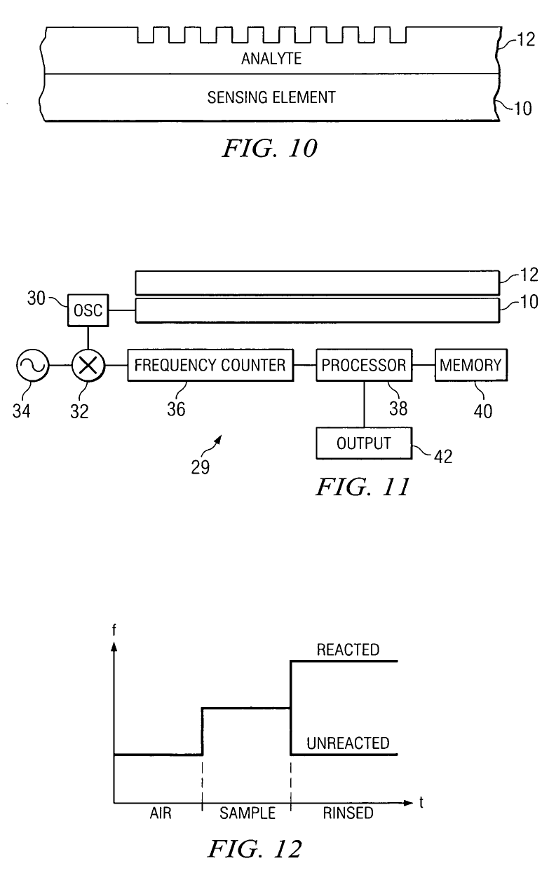

With reference to FIG. 10, after a predetermined period of time has passed, sufficient for a connection between the analyte 12 and the associated material to be completed, the specimen layer 14 is washed away. Because there wasn't any associated material in the sample 14, the analyte is unexposed 12. Because the analyte has essentially the same permittivity both before the sample was introduced and after the sample had been washed away, the conductivity of the sensing element 10 is essentially unchanged. The associated material, therefore, has not been detected in the sample 14.

With reference to FIG. 11, a functional block diagram of a permittivity sensing device 29 for measuring changes in permittivity of a analyte is shown. An analyte 12 is proximate to an sensing element 10. The sensing element will typically be a transmission line, antenna, or other conductive element. The sensing element, in accordance with the disclosed embodiment is a linear antenna.

The analyte may be a chemical, compound or other substance that has an affinity for an associated material. Analytes may be organic lock-and-key compounds, cage compounds including organic cage compounds or inorganic cage compounds, zeolytes, molecular sieves such as cyclodextrins, nanotech structures, dessicants such as anhydrous aluminum oxide, molecular templates, organic porous, inorganic porous, macroporous, microporous, amorphous, crystalline, microcrystalline or ordered compounds such as liquid crystals, sol-gels and other similar types of material. Ideally, the analyte has a low dielectric constant when unexposed and the dielectric compound changes substantially when exposed to the associated material for the particular analyte.

The sensing element 10 is connected to an impedance measuring circuit 30. The impedance measuring circuit 30 may be an unbuffered RF oscillator, bridge circuit, receiver, null bessel, sweep frequency, marginal oscillators or other suitable impedance measurement circuits. In accordance with the disclosed embodiment, the impedance measuring circuit 30 is an unbuffered oscillator. The frequency of an RF unbuffered oscillator 30 is “pulled” (i.e. shifted from the frequency of oscillation which would be seen if the unbuffered oscillator 30 were coupled to an ideal impedance-matched pure resistance), if the oscillator 30 sees an impedance which is different from the ideal matched impedance. Thus, a change in the load impedance may cause the oscillator 30 frequency to shift from a first value to a second value.

The frequency variation may reflect changes in density (due to bonding changes, addition of additional molecular chains, etc.), ionic content, dielectric constant, or microwave loss characteristics of the medium under study. These changes will “pull” the resonant frequency of the oscillator 30. Changes in the medium's magnetic permeability will also tend to cause a frequency change, since the propagation of the RF energy is an electromagnetic process which is coupled to both electric fields and magnetic fields within the transmission line.

An unbuffered oscillator 30 is a oscillator without buffer amplifiers or attenuators. Amplifiers boost the output power and provide isolation from the load impedance changes. Attenuators decrease the amplitude while providing an isolation of two times the attenuation. In the load pulled oscillator configuration (FIG. 21) the oscillator feedback path that supplies the phase shift needed for oscillation is separated from the load.

When an sensing element is proximate to a dielectric material (as, for example, unexposed analyte 12), changes in the composition of the dielectric material (creating exposed analyte 16) may cause electrical changes in the properties of the sensing element 10. These changes may be caused by a chemical reaction, absorption, phase change, polymer changes, etc. In particular, the impedance of the sensing element 10 and the phase velocity of wave propagation in the sensing element 10 are changed.

The frequency of oscillator 30 may be measured by connecting the oscillator 30 to a mixer 32. The mixer is also connected to a controlled-frequency oscillator 34 and provides a differential output signal. The differential output signal from mixer 32 is provided to a frequency counter 36 which measures the frequency of the oscillator 30. The measured frequency is provided to a processor 38 which operates in conjunction with a memory 40. The processor 38 determines the significance of the frequency measured and provides a corresponding output 42.

With reference to FIG. 12, a graph of the resonant frequency of oscillator 30 is shown. When the analyte 12 is unexposed, exposed initially to air, the resonant frequency of the oscillator may be at A cycles per second. When the sample 14 is placed proximate to the analyte 12, the resonant frequency of the oscillator may change to level B cycles per second. In this graph, the frequency B is higher than the frequency A, although the direction of the change is unimportant. If the associated material is present in the sample 14, the associated material reacts with the analyte 12 to form exposed analyte 16. If the associated material is not present in the sample 14, the analyte 12 remains unexposed. When the sample is washed away from the exposed 14 or unexposed 16 analyte, the resonant frequency changes again. If the analyte 14 has exposed, the resonant frequency may be C cycles per second. If the analyte 12 has not exposed, the resonant frequency may be A cycles per second. As shown, frequency C is greater than frequencies A and B. Again, the difference between frequencies C and A is the measured quantity, so as long as there is a difference between frequency A and frequency C, the change in permittivity can be detected. The permittivity of the unexposed analyte 12 may not return to A when the sample 14 has been rinsed. Again, the measurement is one of difference, so as long as the resonant frequency of the oscillator for the unexposed analyte 12 and the exposed analyte 14 is measurably different, the change in permittivity can be detected.

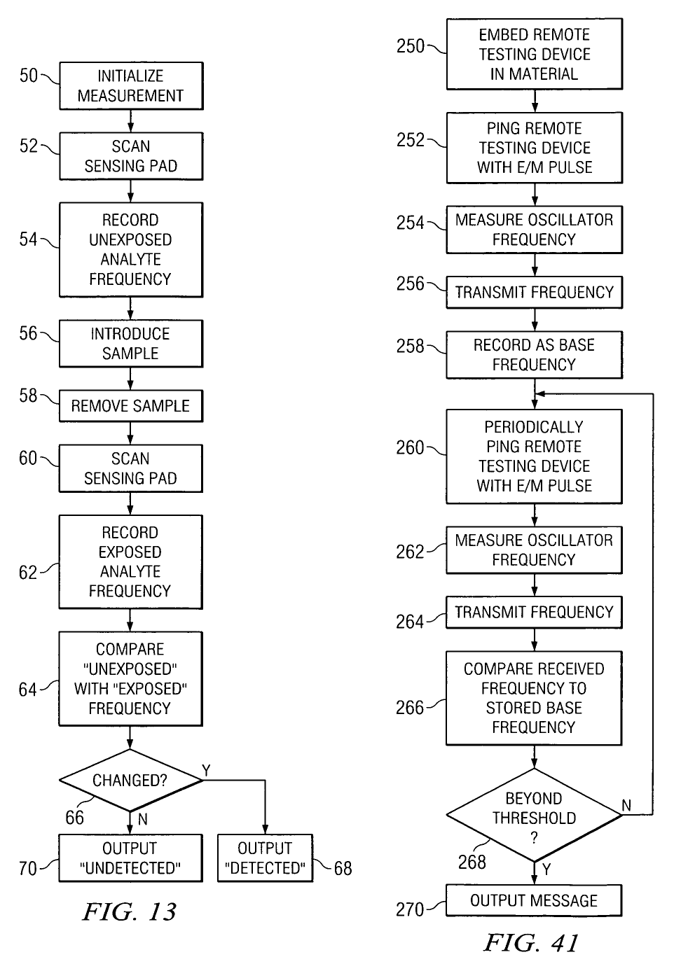

With reference to FIG. 13, a flow chart of a process for detecting the presence of an associated material 18 in a sample 14 using a permittivity sensing device is shown. The process begins at function block 50 where the device is initialized for measurement. The process continues at function block 52 where the permittivity of the sensing pad 8 is measured. The oscillator 30 is energized. The frequency of the oscillator 30 reaches a stable resonant frequency. The frequency of the oscillator 30 is measured and is stored in memory 40 as a “analyte only” frequency. Where the sensing pad 8 is particularly stable or the potential deterioration of the analyte 12 is deemed insignificant, the permittivity of the sensing pad 8 may have been measured at an earlier time and stored in a stable memory device such as an EEPROM.

A sample 14 is introduced proximate to the analyte 12 at function block 56. If an associated material 18 is present in sample 14, the associated material 14 reacts with the analyte 12 to form exposed analyte 16. The sample 14 is removed at function block 58. The removal of specimen layer 14 depends on the chemistry of the sample 14. A gaseous sample 14 may dissipate without intervention. Similarly, a liquid sample 14 may evaporate without intervention. Typically, a liquid sample 14 may be rinsed away with water or some other appropriate solvent. In accordance with other embodiments, the continued presence of sample 14 may be inconsequential to the measurement and the removal step 58 may be omitted.

The permittivity of the sensing pad 8 is measured again in function block 60. The oscillator 30 is energized and reaches a resonant frequency. The frequency of the oscillator 30 is measured and recorded in memory 60 at function block 62 as a “exposed” frequency. The “analyte only” frequency is compared to the “exposed” frequency at function block 64 to determine if the “exposed” frequency is changed from the “analyte only” frequency. The change may further be compared to a predetermined threshold to reject insignificant changes in frequency. The threshold level may be stored in memory 60. The process determines if the frequency has changed at decision block 66. If the frequency has changed, the process continues along the YES path to function block 68 and a “detected” state is output. If the frequency has not changed, the process continues along the NO path to function block 70 and an “undetected” state is output.

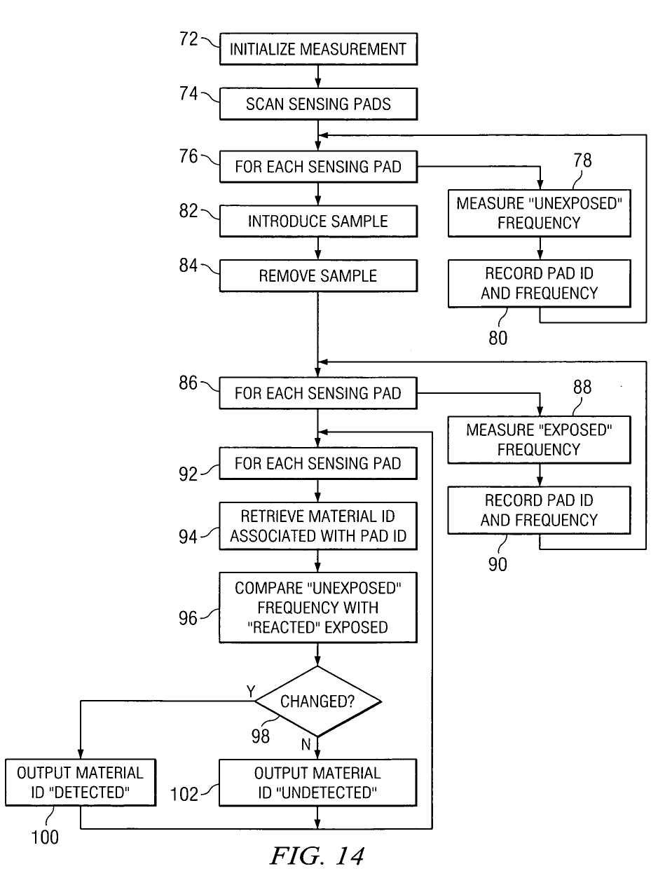

With reference to FIG. 14, a flow chart of a process of detecting a plurality of associated materials 18 in a sample 14 using a plurality of sensing pads 8 in a permittivity sensing device 29 is shown. The process is initialized at function block 72. The process continues to function block 74 which scans the array of sensing pads 8. Function block 76 performs a loop function, cycling through the array of sensing pads 8 to measure the initial resonant frequency of each scanning pad 8. The “unexposed analyte” frequency of the sensing pad 8 is measured at function block 78. A pad identifier and the “unexposed analyte” frequency are recorded in memory 60 at function block 80.

After the “unexposed analyte” frequency of each sensing pad 8 has been measured and recorded, the process continues to function block 82 where a sample 14 is introduced in proximity to analyte 12 of each sensing pad of the array. After sufficient time has passed for the possible reactions between the associated materials 18 and the analytes 12 to be completed, the sample 14 is removed from the sensing pads 8 at function block 84.

The process proceeds to function block 86 which performs another loop function for each of the sensing pads 8 in the sensing pad array. The process measures the resonant frequency of each sensing pad at function block 88. The frequency and a pad identifier are recorded in memory 60 in function block 90.

When the frequency of each sensing pad 8 has been measured, the process continues to function block 92 which performs a loop function for each of the pad identifiers. A material identifier associated with each pad identifier is retrieved from memory 60. The material identifier identifies by name or code the material that reacts with the analyte 12 of the sensing pad 8 associated with the pad identifier. The association between the material being tested for may be more complex than a simple association with the material reaction. The material identifier may correspond to a particular isotope, configuration or concentration of the material tested.

The process continues to function block 96 where the “exposed analyte” frequency is compared to the “unexposed analyte” frequency. The comparison may be a pure comparison or more typically will compare relative to a threshold. The process determines if the “exposed analyte” frequency is changed from the “unexposed analyte” frequency at decision block 98. If the “exposed analyte” frequency is sufficiently changed from the “unexposed analyte” frequency to indicate the material has been detected, the process follows the YES path to function block 100. The material identifier and a “detected” status are output. The process returns to function block 92 where the next sensing pad is tested.

If the “exposed analyte” frequency is not changed from the “unexposed analyte” frequency, the process follows the NO path to function block 102. The material identifier and an “undetected” status are output. The process returns to function block 92 where the next sensing pad is tested.

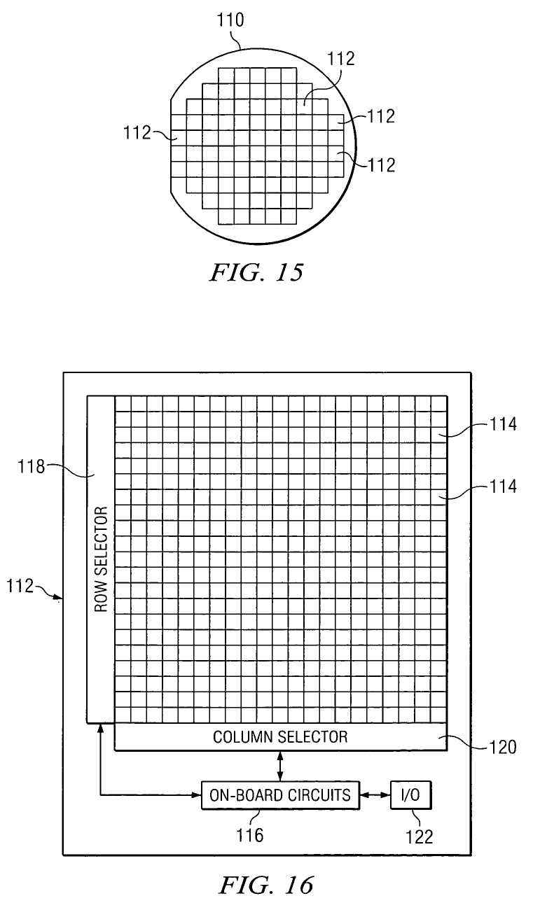

With reference to FIG. 15, a standard silicon wafer architecture is represented. Some or all of the chips which make up the wafer 110 may be material detection array integrated circuits 110.

With reference to FIG. 16, a material detection array integrated circuit 112 is shown. The material detection array integrated circuit 112 includes an array of sensing pad circuits 114. Each of the sensing pad circuits 114 typically tests for a unique material, with some redundancy where desired to provide greater reliability in the tests. On-board circuits 116 which will typically include a processor 38 and memory 40. The on-board circuits 116 may communicate with the sensing pad circuits 114 with a row selector 118 and a column selector 120. The on-board circuits 116 may include an unbuffered oscillator 30, mixer 32, fixed oscillator 34 and frequency counter 36. The on-board circuits communicate with other elements of the system through I/O circuits 122.

The material detection array integrated circuit 112 is typically a single-use device, as the reaction of the analytes 12 are typically irreversible. As such, the material detection array integrated circuit 112 may be built into a disposable test device or may be fashioned as a replaceable test module for attachment to a test device and disposed of after use. The housing of the material detection array integrated circuit may be formed with raised edges around the sensing pad circuits 114, to hold a quantity of liquid sample 14 in contact with each of the sensing pad circuits. Walls may be formed around each sensing pad circuit 114 to permit specific samples to be introduced to specific sensing pad circuits 114 or to prevent the reacting portions of sample 14 to contaminate the reactions taking place with other analytes 12.

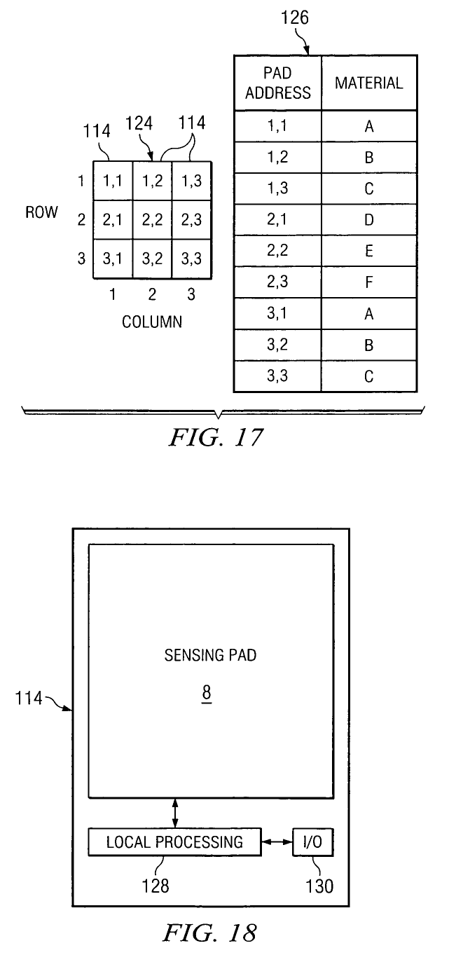

With reference to FIG. 17, charts of the pad identifiers and associated material identifiers in accordance with one embodiment are shown. An array 124 of nine sensing pad circuits 114 are set in a 3×3 array, with (row, column) pad identifiers. In chart 126, each of the nine sensing pads is associated with a material identifier, labeled A, B, C, D, E and F. In the disclosed embodiment, three of the materials, A, B and C are associated with two pads each, to provide greater reliability through redundancy or to measure different concentrations of the material.

With reference to FIG. 18, a sensing pad circuit 114 in accordance with the disclosed embodiment is shown. Sensing pad circuit 114 includes a sensing pad 8 typically composed of a analyte 12 as an upper surface over an sensing element 10. The sensing pad circuit 114 may include local processing 128 including an unbuffered oscillator 30. The local processing 128 may include a mixer 32, fixed oscillator 34, frequency counter 36, processor 38 and memory 40. The local processing 128 may communicate with the on-board circuits 116 of material detection array integrated circuit 112 or other elements of a testing device using I/O circuits 130.

With reference to FIG. 19, a functional block diagram of a permittivity measurement device 131 including a frequency divider 132 is shown. The frequency divider 132 permits a change in frequency between the unbuffered oscillator 30 and the array processing circuits 116, typically to simplify the processing or accommodate circuit operational limitations. The array processing circuits 116 may provide material detection status to the output 134 to indicate the presence or absence of the associated material.

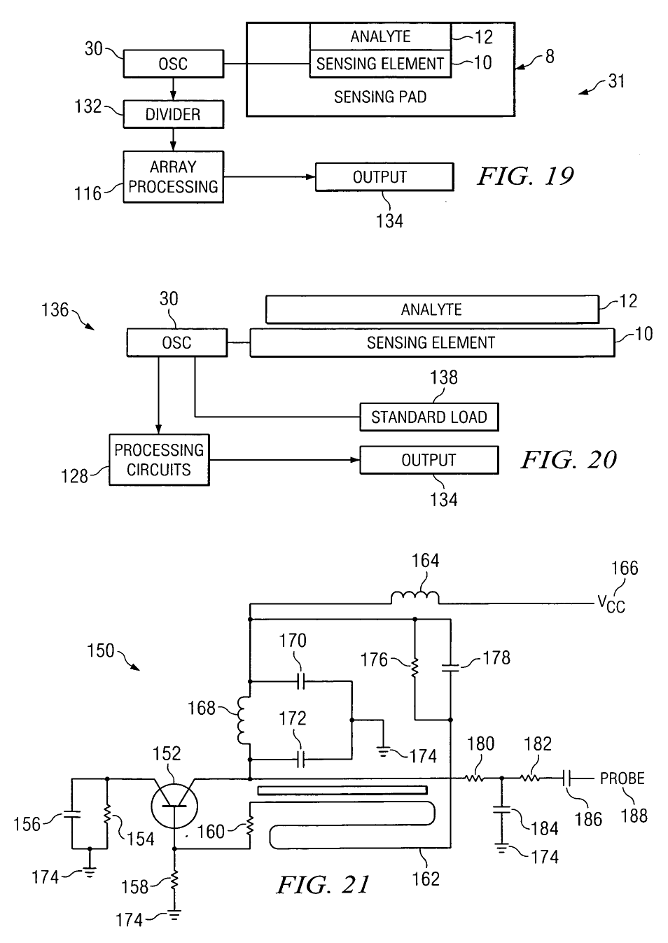

With reference to FIG. 20, a sensing pad circuit 136 in accordance with another embodiment is shown. The sensing pad circuit 136 includes a standard load 138 connected to unbuffered oscillator 30. The standard load 138 generates a reference oscillation frequency when connected to the unbuffered oscillator 30. Changes in frequency due to other factors such as temperature or pressure can be calculated by tracking changes in frequency when the oscillator 30 is connected to the standard load 138. These environmental changes in measurement conditions can be taken into account when the change in the sensing pad frequency is measured.

With reference to FIG. 21, a circuit diagram for a modified Colpitts oscillator with a feedback loop 150 is shown. The modified Colpitts oscillator 150 includes a transistor 152 grounded at the base through a resistance 158 and feedback loop 162 connected via a resistance 160. The collector of the transistor 152 is grounded through a parallel resistance 154 and capacitance 156. The feedback loop 162 is capacitively coupled to itself over a length of 1/32 of the wavelength. A voltage Vcc 166 is connected through inductance 164 to a loop connecting the emitter ends of the capacitive coupling of the feedback look 162. The fore end of the coupling is connected through an inductance 168 grounded at both ends through capacitances 170 and 172. The aft end of the coupling is connected through a parallel resistance 176 and capacitance 178. The aft end of the coupling connects to through probe through resistances 180 and 182 grounded through a capacitance 184 between them. A capacitance 186 connects resistance 182 to the probe 188.

The arrangement of capacitance and resistance at the probe provides a 3 dB pad. The standard resonant frequency of the oscillator 150 is about 705 MHz. The modified Colpitts oscillator 150 has been designed to overcome the poor sensitivity of the standard Colpitts oscillator. The modified Colpitts oscillator 150 enhances the feedback to make the oscillator 150 lock more narrowly than the standard Colpitts oscillator. By narrowing the lock of the oscillator 150, the sensitivity is increased. In the standard Colpitts oscillator, the base and collector of the transistor 152 are 180 degrees out of phase when locked to the frequency formed by the phase of the dielectric medium. In the modified Colpitts oscillator 150, the collector waveform leads the base waveform by 112 degrees. When the value of the dielectric constant changes by a few pico-farads, the oscillator 150 unlocks and these small changes in the dielectric constant may be tracked.

The 112 degree lag changes as the frequency is changed by changes in permittivity of the analyte 12. The 112 degree lag occurs at the associated frequency of 705 MHz. At 500 MHz, the lag is about 79 degrees. This change is due to the length of the fixed delay line.

The modified Colpitts oscillator 150 has the feedback brought back to the transistor output line. This changes the base signal when it is out of phase with the collector signal. If the base signal and the collector signal are coupled 180 degrees out of phase, the feedback signal is cancelled out and the oscillator begins to free-run until it attains a lock. This rejection of the feedback signal, because it is at a lover, keeps the modified Colpitts oscillator 150 from hard locking the way a standard Colpitts oscillator does.

The modified Colpitts oscillator 150 may also be connected to a test sensing element or standard load 138 that may be a terminated length of 140 semi-rigid transmission line. The standard load 138 may be placed near the probe connection such that the output can be switched alternatively between the probe 188 and the standard load 138. Switching or chopping in this manner chops the probe 188 and standard load 138 signals to the base of the transistor 152. The wavelength of the standard load is set for the frequency of a known standard that is being tested by the oscillator 150. This provides a reference frequency for calibrating changes in the testing conditions.

With reference to FIG. 22, a linear sensing element 10 in a descending square configuration, in accordance with one embodiment is shown. The specific shape of the sensing element 10 dictates the particular effect changes in a proximate dielectric will have, such that some shapes will be better suited for some analytes 12 and exposed layers 16.

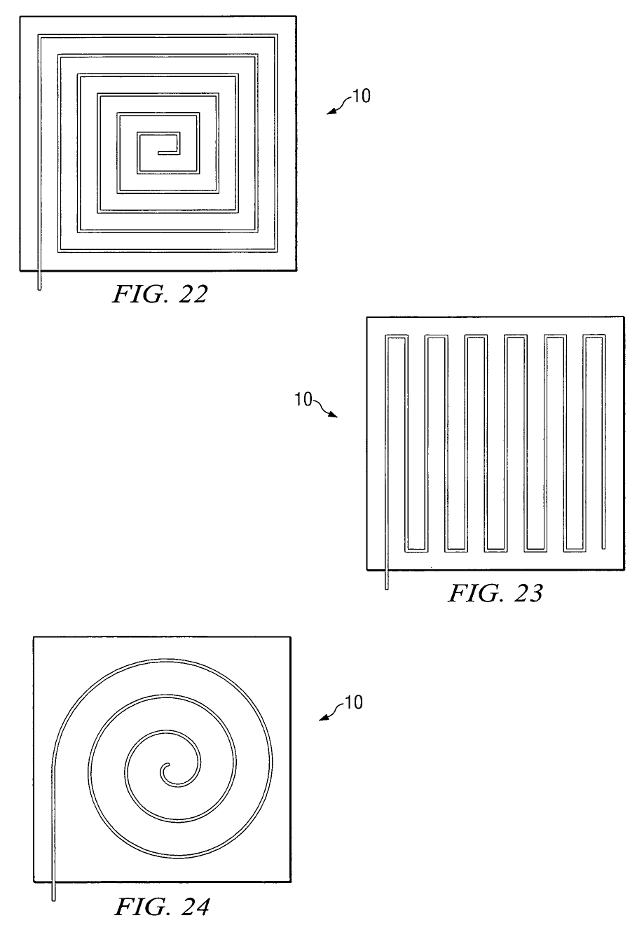

With reference to FIG. 23, a linear sensing element 10 in an progressive square configuration in accordance with one embodiment is shown. As shown, the ends of sensing element 10 are open.

With reference to FIG. 24, a linear sensing element 10 in a closed descending spiral configuration in accordance with one embodiment is shown. As shown, the ends of the sensing element 10 are shorted together, changing the frequency of the standing wave natural to the sensing element 10.

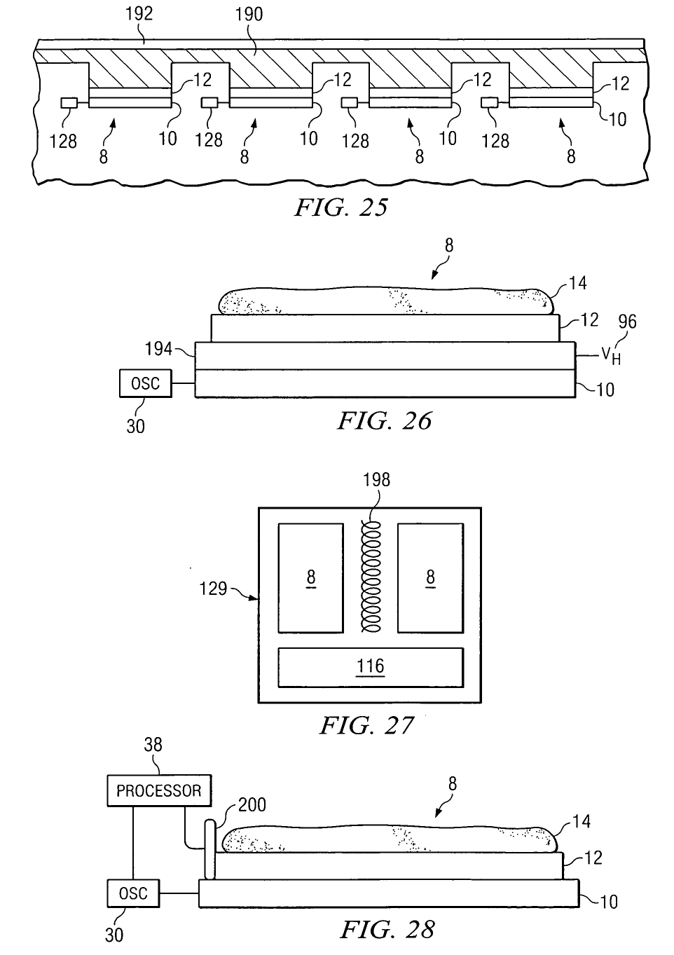

With reference to FIG. 25, a functional block diagram of a portion of an array prepared for shipment is shown. The array includes a plurality of sensing pads 8, each containing an sensing element 10, a analyte 12 and local processing circuitry 128. Each analyte 12 is typically fashioned of a different material, for use in detecting various associated materials. To keep the analytes 12 from reacting prior to use, a thin impermeable layer 192, typically a plastic film, is lain over the surface of the array. The air between the impermeable layer 192 and the surface of the array may be evacuated and the space filled with an inert gas 190. Because the inert gas 190 is generally unreactive, the analytes 12 are not exposed prior to use when the impermeable layer 192 is stripped away and the sample 14 is applied.

With reference to FIG. 26, a sensing pad 8 including a heating layer 194 is shown. Because the reaction between the associated material in sample 14 with the analyte 12 may only occur at a specified temperature, it may be necessary to provide heat to cause the reaction to occur. The sensing pad 8 may include a heating layer 194 between the analyte 12 and the sensing element 10 by applying a heating voltage 196 to the heating layer 194 such that the resistance of the heating layer 194 increases the temperature of the analyte 12. The resonant frequency of unbuffered oscillator 30 may be measured after the reaction has taken place and the analyte 12 has cooled to room temperature.

With reference to FIG. 27, another embodiment for heating the sensing pads 8 in an array 129 is shown. A resistance 198 may be placed proximate to a plurality of sensing pads 8, such that when a voltage is applied to the resistance 198, the sensing pads 8 are heated.

With reference to FIG. 28, a sensing pad 8 including a temperature sensor 200 is shown. The resonant frequency of oscillator 30 may depend on the temperature of the sensing pad 8. A temperature sensor 200 may be connected to processor 38 such that the temperature of the sensing pad 8 can be measured by the temperature sensor 200. The processor 38 may then take the temperature into account when determining if the change in frequency of the oscillator 30 indicates the presence of an associated material in the sample 8.

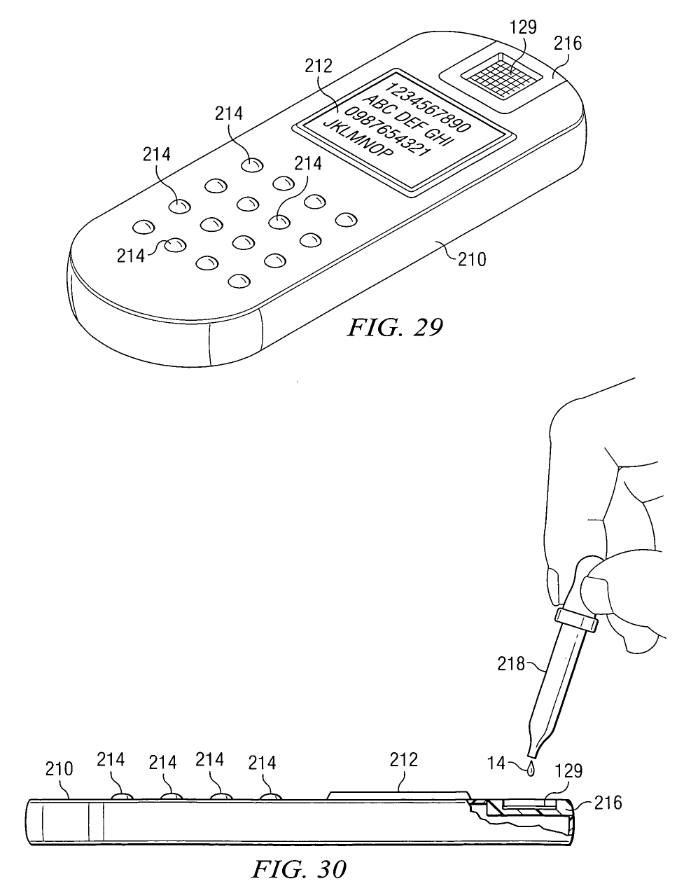

With reference to FIG. 29, a portable material detection device 210 is shown. The portable material detection device 210 may be approximately the size of a cellular telephone or an infrared remote control. The portable material detection device 210 may be powered by battery cells. A removable cartridge 216 including a material detection array integrated circuit 129 may be connected to the portable material detection device 210 for testing. When the detection process is completed, the removable cartridge 216 may be removed and discarded. Different removable cartridges 216 may be used in the same portable material detection device to test for different materials. The definition of the materials and threshold frequencies may be stored on EEPROM in the removable cartridge. A visual display 212 such as an LCD screen may be used to display information regarding the detection of materials including the material detected, the materials not detected, the test parameters and data and conclusions that can be drawn from the detection. Input devices 214 may be included to start the process, to select various displays or to otherwise set parameters for the portable material detection device 210 and processes performed by the portable material detection device 210.

With reference to FIG. 30, a cross-section diagram showing the use of a portable material detection device 210 is shown. A sample 14 is introduced to the material detection array 129 by sample delivery mechanism 218, such as a dropper.

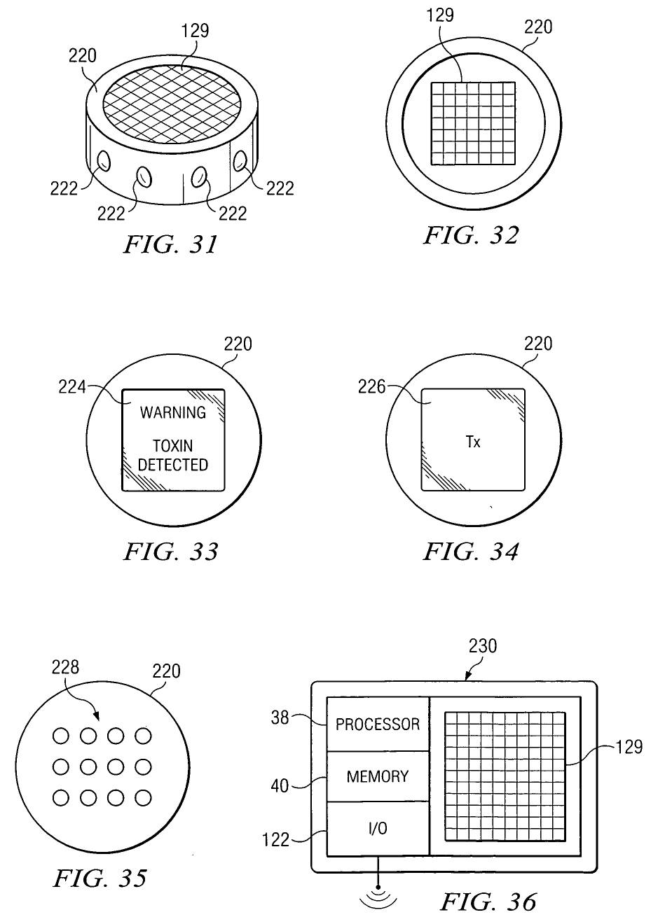

With reference to FIGS. 31-35, a portable material detection device 220 in accordance with other embodiments is shown. Portable material detection device 220 may be a cylindrical casing of less than an inch in diameter and a half inch in height. One circular end of the portable material detection device 220 may have a single sensing pad 8 or a material detection array 129. The portable material detection device 220 in accordance with this embodiment may be used to detect the presence of toxic gas or air-borne biological contaminants. The other circular side of the portable material detection device 220 may have a visual display 224 such as an LCD. The visual display may visually warn the user of the presence of toxic chemicals or contaminants. The portable material detection device 220 may include a transmitter 226. Portable material detection devices 220 may be scattered throughout a facility or area and transmit warning signals to a central base when chemicals or contaminants are detected. Portable material detection device 220 may include a speaker 228 to broadcast aural warning signals when a chemical or contaminant is detected. Manual input buttons 222 may be placed on the outer surface of the portable material detection device 220.

With reference to FIG. 36, a portable material detection device 230 in accordance with another embodiment is shown. An integrated circuit including a sensing pad 8 or a material detection array 129, a processor 38, memory 40 and an I/O circuit 122 such as a transmitter may function as a portable material detection device 230. The integrated circuit may be of any appropriate size, including smart dust. The portable material detection device 230 may be battery powered or energized by polling energy bursts. This type of portable material detection device 230 may be particularly well suited for remotely detecting conditions within a closed environment, such as testing for water within a product or material contamination or deterioration within a material. The portable material detection device 230 may transmit a warning signal to a central base when an associated material is detected or may transmit whenever the device is polled.

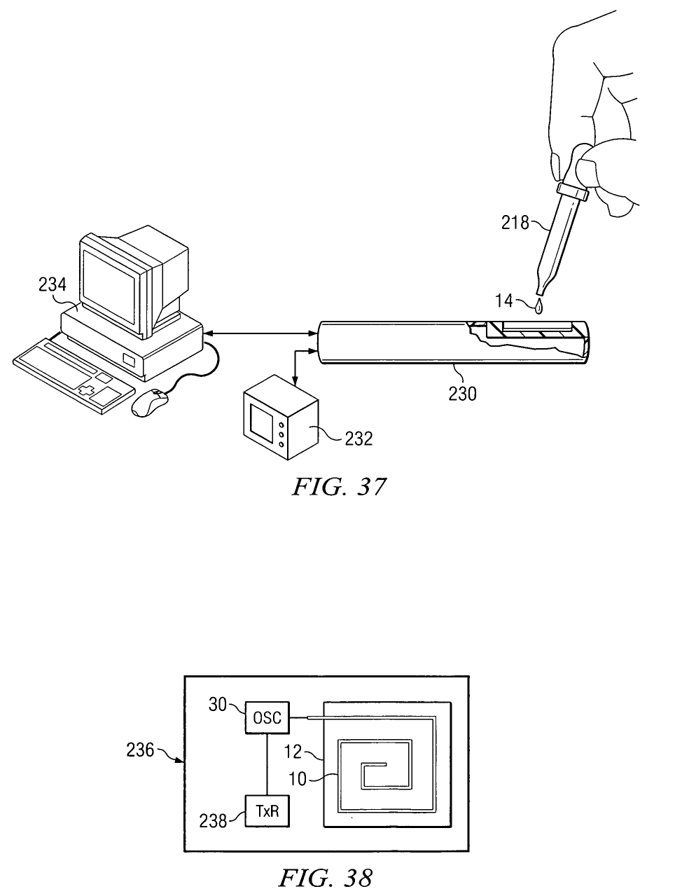

With reference to FIG. 37, the use of a portable material detection device 230 is shown. In this embodiment, the portable material detection device is used for remote testing of a sample 14. The sample 14 is introduced to the portable material detection device 230 by a sample introduction mechanism 218. The permittivity frequency tests are conducted by the portable material detection device 230 and transmitted to a remote processing device 232 or a computer 234 programmed to conduct the processing functions. The transmission may be a wireless communication or a wired communication. The transmission may use a mixture of media, including a wireless network, the Internet or other communication networks.

With reference to FIG. 38, a portable material detection device 236 is shown. The portable material detection device 236 includes an sensing element 10, an oscillator 30 and a transmitter 238. The portable material detection device 236 in accordance with this embodiment is particularly suitable for detecting changes in an embedding material. The portable material detection device 236 may be embedded in a material such as fiber-glass, epoxy, aluminum, concrete or any other substance, particularly structural substances. Where the substance is conductive, a dielectric layer may be placed between the sensing element and the substance. The portable material detection device may be placed on the surface of a structure, such as an airplane wing, to detect the presence of ice by the phase change from water. As the substance changes due to age, strain, contamination, or phase changes the permittivity of the substance may change. This change can be detected in the same manner as the material detection described above. This type of portable material detection device 236 may periodically check the condition of the substance and transmit whenever the change reaches a threshold, or may be polled.

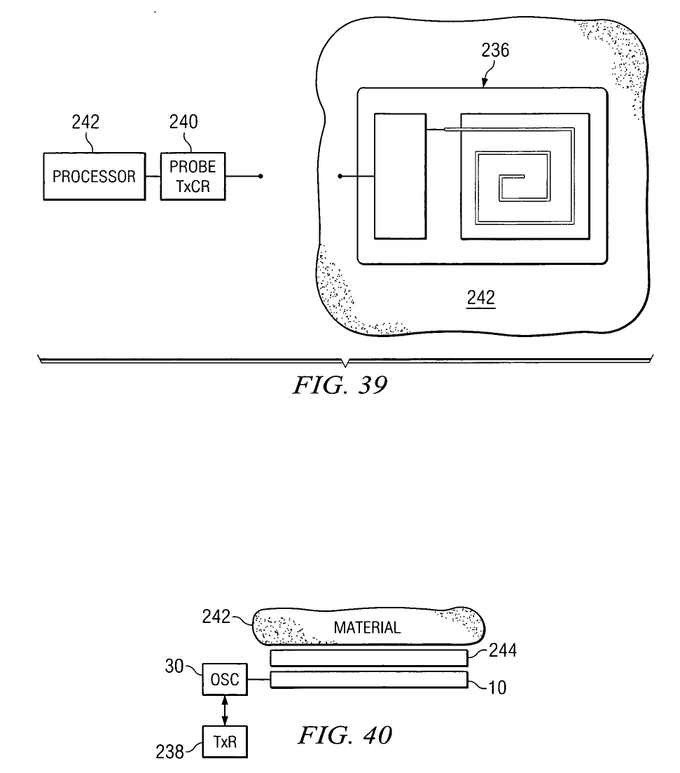

With reference to FIG. 39, a portable material detection device 236 is shown embedded in a substance 242. A probe transceiver 240 sends a polling signal to the portable material detection device 236. The portable material detection device 236 measures the permittivity of the substance 242 in response to the polling signal and sends a measurement signal to the probe transceiver 240 in return. The measurement signal is then processed by the processor 242 to determine if the substance 242 has changed in a detrimental way.

Withe reference to FIG. 40, a functional block diagram of portable material detection device 236 is shown. An unbuffered oscillator 30 communicates with a transmitter 238. The unbuffered oscillator 30 is connected to an sensing element 10 which acts as a load pull on the unbuffered oscillator 30 to determine the resonant frequence of the oscillator 30. A material 242 is placed proximate to the sensing element 10, typically electrically isolated by a dielectric layer 244. As the permittivity of the material changes due to age, stress, contamination or other conditions, the load pull of the sensing element 10 on the unbuffered oscillator 30 changes.

With reference to FIG. 41, a flowchart of a process for testing material conditions using a portable material detection device 236 is shown. The portable material detection device 236 is embedded in a material 242 in function block 250. The portable material detection device 236 is polled with an electromagnetic pulse in function block 252. The resonant frequency of the unbuffered oscillator 30 is measured in function block 254. The frequency measurement is transmitted in function block 256. The received frequency measurement is stored as a base frequency in function block 258.

The portable material detection device 236 is polled periodically with an electromagnetic pulse at function block 260. The resonant frequency of the oscillator is measured at function block 262 and the measured frequency is transmitted at function block 264. The received frequency is compared to the stored base frequency at function block 266. If the difference between the received frequency and the stored base frequency is beyond a predetermined threshold at decision block 268, the process follows the YES path to output a “material change” message at function block 270. If the difference is not beyond the predetermined threshold at decision block 268, the process follows the NO path to wait for the next period polling at function block 260.

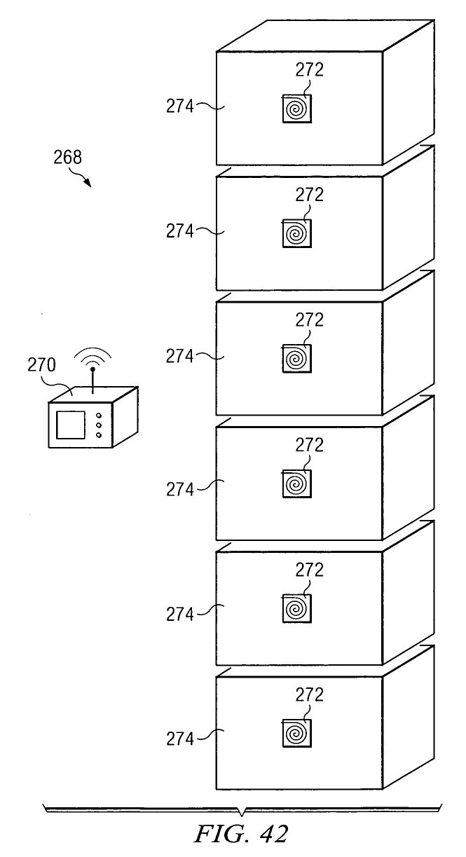

With reference to FIG. 42, a material condition detection system 268 is shown. The material condition detection system 268 includes a portable material condition processor 270 in communication with a plurality of portable material condition sensors 272, each embedded in one or more materials 274. The materials 274 may be boxes of goods, pillars in a building, frame components in an airplane or any other substance that may change condition by age, stress, contamination or other types of deterioration. The portable material condition processor 270 may poll the portable material condition sensors 272. Each portable material condition sensors may perform a permittivity test to determine changes in permittivity of the materials 274. The test results are transmitted back to the portable material condition processor 270 where the changes in condition are determined and output to the user.

It will be appreciated by those skilled in the art having the benefit of this disclosure that this invention provides a system and method of material testing using permittivity measurements. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A system for material testing comprising:
a sensing element; and
an analyte substantially in contact with said sensing element;
an impedance measuring circuit connected to said sensing element;
wherein said analyte, when exposed to an associated material, alters the impedance of the sensing element.

2. The system for material testing of claim 1, wherein said sensing element is a transmission line.

3. The system for material testing of claim 1, wherein said sensing element is an antenna

4. The system for material testing of claim 1, wherein said impedance measuring circuit is an unbuffered oscillator.

5. The system for material testing of claim 4, wherein said unbuffered oscillator is a modified Colpitts oscillator.

6. The system for material testing of claim 1, wherein said analyte is a cage compound.

7. The system for material testing of claim 1, wherein said analyte is a zeolyte.

8. The system for material testing of claim 1, wherein said analyte is an inorganic porous material.

9. The system for material testing of claim 1, wherein said analyte is an organic porous material.

10. The system for material testing of claim 1, wherein said analyte is a molecular template.

11. The system for material testing of claim 1, wherein said analyte is a macroporous material.

12. The system for material testing of claim 1, wherein said analyte is a microporous material.

13. The system for material testing of claim 1, wherein said analyte is an amorphous material.

14. The system for material testing of claim 1, wherein said analyte is a crystalline material.

15. The system for material testing of claim 1, wherein said analyte is a microcrystalline material.

16. The system for material testing of claim 1, wherein said analyte is an ordered material.

17. The system for material testing of claim 1, wherein said system is fabricated on an integrated circuit.

18. The system for material testing of claim 4, further comprising a frequency meter connected to said unbuffered oscillator for measuring the frequency of the unbuffered oscillator.

19. The system for material testing of claim 18, wherein said frequency meter comprises a mixer connected to said unbuffered oscillator, a controlled frequency oscillator connected to said mixer and a frequency counter connected to the output of said mixer.

20. The system for material testing of claim 18, further comprising a processor connected to the frequency meter for processing the measured frequencies of the unbuffered oscillator.

21. The system for material testing of claim 20, wherein said processing includes determining if an associated material has been detected.

22. The system for material testing of claim 3, wherein said antenna is a linear antenna.

23. The system for material testing of claim 1, wherein said associated material is an organic compound.

24. The system for material testing of claim 20, wherein said processing includes determining if an associated material has been detected at a predetermined concentration.

25. The system for material testing of claim 1, wherein said system is portable.

26. The system for material testing of claim 1, further comprising an transmitter connected to said impedance measuring circuit.

27. The system for material testing of claim 20, further comprising a visual display connected to said processor.

28. The system for material testing of claim 20, further comprising manual inputs connected to said processor.

29. The system for material testing of claim 26, further comprising a remote receiver for receiving transmissions from said transmitter.

30. The system for material testing of claim 29, further comprising a receiver connected to said impedance measuring circuit and a remote transmitter for sending a polling signal to said receiver.

31. The system for material testing of claim 1, comprising a plurality of sensing elements and a plurality of analytes, wherein each of said plurality of analytes changes the impedance of an associated sensing element when exposed to a different associated material.

32. The system for material testing of claim 31, comprising a plurality of impedance measuring circuits wherein each of said plurality of impedance measuring circuits are connected to an associated one of said plurality of sensing elements.

33. The system for material testing of claim 31 wherein said system is fabricated on an integrated circuit.

34. The system for material testing of claim 32 wherein said system is fabricated on an integrated circuit.

35. A method for material testing comprising:
providing an impedance measuring circuit connected to a sensing element, wherein said sensing element is proximate to a analyte;
measuring a first impedance of the sensing element with the impedance measuring circuit;
said analyte to an associated material;
measuring a second impedance of the sensing element with the impedance measuring circut;
comparing said first impedance and said second impedance to detect the associated material.

36. The method for material testing of claim 35, wherein said sensing element is a transmission line.

37. The method for material testing of claim 35, wherein said sensing element is an antenna.

38. The method for material testing of claim 35, wherein said impedance measuring circuit is an unbuffered oscillator.

39. The method for material testing of claim 38, wherein said unbuffered oscillator is a modified Colpitts oscillator.

40. The method for material testing of claim 35, wherein said analyte is a cage compound.

41. The method for material testing of claim 35, wherein said analyte is a zeolyte.

42. The method for material testing of claim 35, wherein said analyte is an inorganic porous material.

43. The method for material testing of claim 35, wherein said analyte is an organic porous material.

44. The method for material testing of claim 35, wherein said analyte is a molecular template.

45. The method for material testing of claim 35, wherein said analyte is a macroporous material.

46. The method for material testing of claim 35, wherein said analyte is a microporous material.

47. The method for material testing of claim 35, wherein said analyte is an amorphous material.

48. The method for material testing of claim 35, wherein said analyte is a crystalline material.

49. The method for material testing of claim 35, wherein said analyte is a microcrystalline material.

50. The method for material testing of claim 35, wherein said analyte is an ordered material.

51. The method for material testing of claim 35, wherein said impedance measuring circuit, said sensing element and said analyte are fabricated on an integrated circuit.

52. The method for material testing of claim 38, wherein said impedance measurements are conducted by a frequency meter connected to said unbuffered oscillator.

53. The method for material testing of claim 52, wherein said frequency meter comprises a mixer connected to said unbuffered oscillator, a controlled frequency oscillator connected to said mixer and a frequency counter connected to the output of said mixer.

54. The method for material testing of claim 52, further comprising processing the impedance measurements of the unbuffered oscillator.

55. The method for material testing of claim 54, wherein said processing includes determining if an associated material has been detected.

56. The method for material testing of claim 37, wherein said sensing element is a transmission line.

57. The method for material testing of claim 35, wherein said associated material is an organic compound.

58. The method for material testing of claim 54, wherein said processing includes determining if an associated material has been detected at a predetermined concentration.

59. The method for material testing of claim 35, wherein said impedance measuring circuit, said sensing element and said analyte are fabricated to be portable.

60. The method for material testing of claim 35, further comprising an transmitter connected to said impedance measuring circuit.

61. The method for material testing of claim 54, further comprising visually displaying results of the processing.

62. The method for material testing of claim 54, further comprising manually inputting parameters for the processing.

63. The method for material testing of claim 60, further comprising receiving transmissions from said transmitter at a remote receiver.

64. The method for material testing of claim 63, further comprising receiving a polling signal at said receiver.

65. The method for material testing of claim 35, comprising a plurality of sensing elements and a plurality of analytes, wherein each of said plurality of analytes changes the impedance of an associated sensing element when exposed to a different associated material.

66. The method for material testing of claim 65, comprising a plurality of impedance measuring circuits wherein each of said plurality of impedance measuring circuits are connected to an associated one of said plurality of sensing elements.

67. The method for material testing of claim 65 wherein said plurality of sensing elements and said plurality of analytes are fabricated on an integrated circuit.

68. The method for material testing of claim 66 wherein said plurality of impedance measuring circuits are fabricated on an integrated circuit.

69. An integrated circuit for material testing comprising:
an impedance measuring circuit;
an sensing element connected to said impedance measuring circuit; and
a substance proximate to said sensing element such that the substance affects the impedance of the sensing element;
wherein when said substance changes, the impedance of the sensing element is changed.

70. The integrated circuit of claim 69, wherein said impedance measuring circuit is an unbuffered oscillator.

71. The integrated circuit for material testing of claim 70, wherein said unbuffered oscillator is a modified Colpitts oscillator.

72. The integrated circuit for material testing of claim 70, further comprising a frequency meter connected to said unbuffered oscillator for measuring the frequency of the unbuffered oscillator.

73. The integrated circuit for material testing of claim 72, wherein said frequency meter comprises a mixer connected to said unbuffered oscillator, a controlled frequency oscillator connected to said mixer and a frequency counter connected to the output of said mixer.

74. The integrated circuit for material testing of claim 70, further comprising a processor connected to the impedance measuring circuit for processing the impedance measurements of the sensing element.

75. The integrated circuit for material testing of claim 74, wherein said processing includes determining if said substance has changed.

76. The integrated circuit for material testing of claim 70, wherein said sensing element is an antenna.

77. The integrated circuit for material testing of claim 70, wherein said change is due to strain.

78. The integrated circuit for material testing of claim 70, wherein said change is due to contamination.

79. The integrated circuit for material testing of claim 76, wherein said processing includes determining if said change is significant.

80. The integrated circuit for material testing of claim 70, further comprising an transmitter connected to said impedance measuring circuit.

81. The integrated circuit for material testing of claim 74, further comprising a visual display connected to said processor.

82. The integrated circuit for material testing of claim 74, further comprising manual inputs connected to said processor.

83. The integrated circuit for material testing of claim 80, further comprising a remote receiver for receiving transmissions from said transmitter.

84. The integrated circuit for material testing of claim 70, further comprising a receiver connected to said impedance measuring circuit and a remote transmitter for sending a polling signal to said receiver.

85. A method for material testing comprising:
providing an integrated circuit including an impedance measuring circuit connected to a sensing element, wherein said sensing element may be placed proximate to a substance;
measuring a first impedance of the sensing element proximate to the substance;
measuring a second impedance of the sensing element proximate to the substance; and
comparing said first impedance and said second impedance to detect changes in the substance.

86. The method for material testing of claim 85, wherein said impedance measuring circuit is an unbuffered oscillator.

87. The method for material testing of claim 86, wherein said unbuffered oscillator is a modified Colpitts oscillator.

88. The method for material testing of claim 86, wherein said impedance measurements are conducted by a frequency meter connected to said unbuffered oscillator.

89. The method for material testing of claim 88 wherein said frequency meter comprises a mixer connected to said unbuffered oscillator, a controlled frequency oscillator connected to said mixer and a frequency counter connected to the output of said mixer.

90. The method for material testing of claim 85, further comprising processing the measured impedances.

91. The method for material testing of claim 90 wherein said processing includes determining if the substance has changed.

92. The method for material testing of claim 85, wherein said sensing element an antenna

93. The method for material testing of claim 85, further comprising an transmitter connected to said impedance measuring circuit.

94. The method for material testing of claim 90, further comprising visually displaying results of the processing.

95. The method for material testing of claim 90, further comprising manually inputting parameters for the processing.

96. The method for material testing of claim 93, further comprising receiving transmissions from said transmitter at a remote receiver.

97. The method for material testing of claim 96, further comprising receiving a polling signal at a receiver connected to said impedance measuring circuit.
